(19) United States
(12) Patent Application Publication
(10) Pub. No.: US 2007/0005516 A1
(43) Pub. Date: Jan. 4, 2007

(54) System, method and program to define, approve and draft a contract

(75) Inventors: Diana Lee Murray, Thornton, CO (US); Harry Dee Tillman, Fort Collins, CO (US)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 11/172,243

(22) Filed: Jun. 30, 2005

(51) Int. Cl. G06Q 99/00; H04K 1/00; H04L 9/00

(52) U.S. Cl. 705/80; 705/1

(57) ABSTRACT

System, method and program for defining and approving first and second services of a contract. First program instructions solicit from at least one person first and second descriptions of the first and second services, respectfully. Second program instructions respond to receipt of the first and second descriptions, by notifying at least one approver that the first and second services are ready for approval. Third program instructions responsive to receipt of the approval, by advancing a status of the first and/or second services, respectively and determining a status of the contract. The status of the contract is based on status of both the first and second services. In accordance with other features of the present invention, fourth program instructions automatically enter some of the first and second descriptions into a document to form the contract. In response to approval by the approver of the first and second services, the third program instructions advance a status of the contract.

### BACKGROUND

The present invention relates generally to computer software, and more specifically to a computer program to define and approve terms of a contract and draft the contract.

Various types of formal contracts are used today, such as a contract for computer services. An attorney or contracts administrator may be responsible for drafting the contract. The attorney or contracts administrator typically begins with a standard contract for the type of product or service being provided and then modifies and customizes the standard contract as needed for the current situation. The modifications and customizations can specify the products or services to be provided, and may be provided in the main body of the contract or as a “Statement of Work” attached to the main contract. The attorney or contracts administrator typically consults with one or more people responsible for performing the contract, to understand the current situation and what terms are needed. While this is effective, it could be better coordinated with the people responsible for performing the contract to ensure that the terms of the contract are correct.

Various types of informal contracts are used today such as a “Document of Understanding” (“DOU”). A DOU is often used within a corporation (or other type of company) to define responsibilities of different organizations within the same corporation. It is informal in the sense that organizations within the same corporation are not separate legal entities, and therefore are not legally bound to the terms of the DOU. Nevertheless, it is often important to clearly state in writing the responsibilities of the different organizations involved in a mutual endeavor, such as to estimate the cost of providing a service to a DPE or provide the actual service. It is also important that this document accurately states the responsibilities. It was known for an administrator to begin with a standard DOU for the type of product or service to be provided, and then modify and customize it as needed for the current situation. The customizations can specify the products or services to be provided, and may be provided in the main body of the DOU or as a “Statement of Work” attached to the main body of the DOU. The administrator typically consults with one or more people responsible for performing the responsibilities, to understand the current situation and what terms are needed. While this is effective, it could be better coordinated with the people responsible for performing the responsibilities to ensure that the terms of the DOU are correct.

It was also known to provide a template document containing predefined text and variables, and for a user to specify a “value” for each of the variables. The “value” could be a name, word, numerical number, etc. After the user specifies the value of each variable, a program tool substitutes the value for each variable in the document to complete the document.

It was known for various processes to automatically initiate requests for approvals. For example, if an employee submits an expense account into a known expense management program system, the expense management program system will automatically request approvals for the expense accounts.

A known IBM Service Request (SR) (program) Tool operates as follows. A person creates a service request and in the request, defines tasks of the service. This initiates a process of manually sizing the service, and requesting approval. There are several steps and status corresponding to the service request. The initial status for a service request is “Draft”. The first step is for a requester to submit a service request and in response, the tool updates the status to “Delivery Project Executive”. A Delivery Project Executive must review the service and approve the service request and then the tool updates the status to “Coordinator”. The second step is for a Coordinator to be assigned and approved by an SR Coordinator. The SR Coordinator then assigns a review team for the service request and changes the status to “Review Representative”. The third step is for the SR Coordinator to conduct a meeting between the parties responsible for providing the service to the customer. Once the meeting has taken place and the service request is understood by the service provider, the SR coordinator can update the service request status to “Sizing”. The fourth step is for a Sizer to give an estimate for processing the service request. Once the sizing is completed, the SR coordinator can estimate the cost of the service request and update the status for the service request “Management Review”. The fifth step is for a Management Reviewer to approve the service request. Once the service provider owner/manager approves the service request, the SR Coordinator can change the status of the service request to “Coster”. The sixth step is for a Coster to estimate how much the service request will cost to the SR Coordinator. Once the cost is estimated, the SR Coordinator can change the status of the service request to “Delivery Project Executive Final Review”. The seventh is for a Delivery Project Executive (“DPE”) to perform final review of the service request. Once the DPE approves the service Request, the service request status changes to Complete.

A known IBM New Business Database (NBD) is similar to the IBM Service Request tool although there is one less step in processing a service request. The initial status is “Draft”. The first step is for a requester to submit a service request which in turns updates the status to “Requirement”. The second step is an NBD coordinator to gather basic information from the requester about the service and define who needs to size the service request. Next, the NBD coordinator updates the service request status to “Sizing”. The third step is for a service provider to size, i.e. estimate the cost of, the service request. After the service has been sized, the NBD coordinator must update the status for the service request to “Business Area Manager”. The fourth step is for the owner of the service to approve the service request. After the approval, the NBD coordinator must update the service request status to “Implementation Approver”. The fifth step is for an implementation approver to approve the service request. After this approval, the NBD coordinator must update the service request status to “Production Ready”.

An object of the present invention is to coordinate the definition and approval or terms of a contract (formal or informal) or other such document, and the drafting of the contract or other such document.

### SUMMARY OF THE INVENTION

The present invention resides in a system, method and program for defining and approving first and second services of a contract. First program instructions solicit from at least one person first and second descriptions of the first and second services, respectfully. Second program instructions respond to receipt of the first and second descriptions, by notifying at least one approver that the first and second services are ready for approval. Third program instructions responsive to receipt of the approval, by advancing a status of the first and/or second services, respectively and determining a status of the contract. The status of the contract is based on status of both the first and second services.

In accordance with a feature of the present invention, fourth program instructions automatically enter some of the first and second descriptions into a document to form the contract. In response to approval by the approver of the first and second services, the third program instructions advance a status of the contract.

### BRIEF DESCRIPTION OF THE FIGURES

FIG. 1 is a block diagram of a distributed computer system which incorporates the present invention.

FIGS. 2(A-C) form a flow chart illustrating programming and processes for defining and approving terms of a contract (formal or informal), and drafting the contract within the distributed computer system of FIG. 1, according to the present invention.

FIG. 3 is a flow chart illustrating a DOU creation program within the programming of FIGS. 2(A-C).

### DETAILED DESCRIPTION OF THE PREFERRED EMBODIMENTS

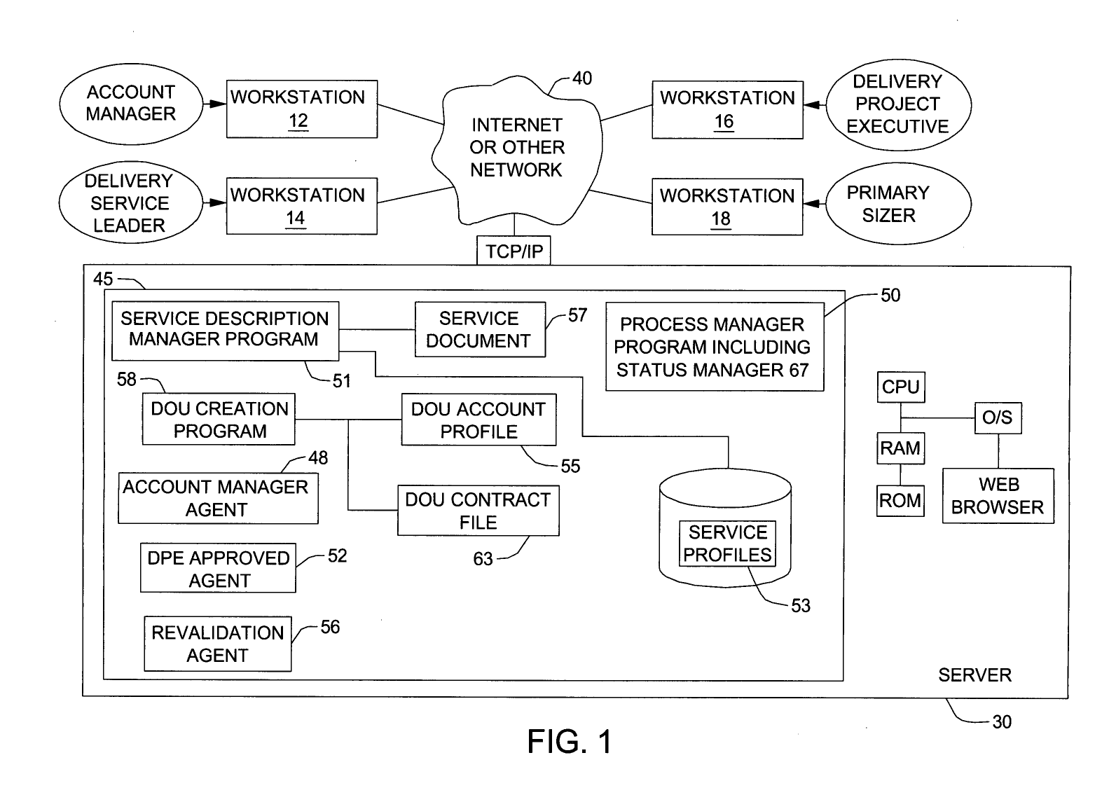

The present invention will now be described in detail with reference to the Figures. FIG. 1 illustrates a distributed computer system 10 in which the present invention is embodied. System 10 includes computer workstations 12, 14, 16 and 18 used by an Account Manager, Delivery Service Leader, Delivery Project Executive, and Primary Sizer, respectively to enter their information defining Services and other terms of a proposed contract (formal or informal) and/or enter their approvals for the Service, other terms of a proposed contract defined by someone else or the contract itself. Each of the workstations 12, 14, 16 and 18, and server 30 includes a CPU, RAM, ROM, Storage, operating system, web browser and TCP/IP adapter card to interface to Internet 40. A Service and DOU manager program 45 within server computer 30 generates user interface screens to enable each of the Account Manager, Delivery Service Leader, Delivery Project Executive and Primary Sizer to reviews Service documents and/or a DOU document, and enter their information and/or approvals. Program 45 can send these screens to the workstations 12, 14, 16 and 18 of the Account Manager, Delivery Service Leader, Delivery Project Executive and Primary Sizer, respectively, in HTML format via Internet 30 for display using a web browser. Alternately, network 40 can be an Intranet or other network depending on the interconnection available to the Account Manager, Delivery Service Leader, Delivery Project Executive and Primary Sizer. Program 45 coordinates the entry of the information defining the Services and other terms of the contract and the approvals, and automatically creates the resultant contract based on this information. Thus, different people define and approve the Services, and program 45 within server 30 automatically captures these terms and approvals. When the requisite people provide the requisite approvals for each Service and the contract, program 45 automatically generates the contract.

The following are general descriptions of various terms used below in the description of program 45 and processes for defining and approving terms of a contract, and drafting the contract. Even though the following process and description references an informal contract, i.e. a DOU, analogous steps apply to formal contracts as well (except that approvals are required from both the service provider and external customer).

“Service” is a technical solution or service provided by a service provider to a Delivery Project Executive. In the case of the DOU between different organizations of the same company, the Delivery project executive is the recipient of and payer for the service. (When the contract is “formal”, the external customer replaces the Delivery project executive as the recipient of and payer for the service.) By way of example, the Services can be computer services. Each Service typically comprises a collection or series of tasks. A DOU specifies one or more (typically multiple) services to be performed.

“Primary sizer” is a person employed by the service provider who is responsible for “sizing” a service, i.e. estimating the cost of performing the service.

“Delivery Service Leader” (“DSL”) is a person employed by the service provider who is responsible for approving one or a subset of services of a DOU which have been defined.

“Delivery Project Executive” (“DPE”) is a person employed by the service provider who is responsible for approving all the services of a DOU. (The Delivery Project Executive is also responsible for approving all services.)

“Service Profile” is a predefined/default description of a Service being provided to the Delivery Project Executive. Server 30 stores the Service Profiles.

“Sizing” means to identify tasks (including labor, hardware and software) of each Service and estimate the cost of each task.

“DOU Account Profile” is a file containing descriptions of Services and a DOU offered to a Delivery Project Executive or DPE.

“Account Manager” is a person employed by the service provider who is responsible for gathering information for and customizing each of the Services contained in a DOU Account Profile.

“Archive Database” is a database within or associated with computer 30 to store old or unused DOUs, Services, and Word DOU Contracts.

“DOU” represents a type of informal contract between different people or internal organizations within the same company, or between an external customer and organizations providing the service.

“Service Request” (“SR”) is a document which outlines a Service requested by an internal organization, external customer or DPE. The SR can be a preexisting form for a respective Service, or the Account Manager can manually enter the SR.

“Account Manager Agent” 48 is a program module within a “Work Flow (Program) Tool” 50 that executes periodically within computer 30, such as nightly to update DOUs and notify an Account Manager when a DOU is ready for him or her to reviewed and modify as needed.

“DPE Approval Agent” 52 is a program module within the Work Flow Tool 50 that executes periodically within computer 30, such as nightly to update Services and notify the Account Manager when the DOU is approved.

“Revalidation Agent” 56 is a program module within the Work Flow Tool 50 that executes infrequently such as yearly to archive and update DOUs, DOU Contracts, and Services. Also, a DOU may require yearly confirmation in which case the Revalidation Agent notifies the Account Manager when such a DOU needs to be confirmed or re-approved.

### Status of Services and DOU

Each Service of a DOU is defined in stages having Status 0 to 7 as follows, and the associated DOU (for one or more such Service) is created in stages having Status 1-7, as follows:

Status 0: On Hold, Canceled, Rejected (“exception” status in the program)

Status 1: Draft

Status 2: Pending Sizing (or Work in Progress)

Status 3: Account Manager Costing

Status 4: Pending DSL Approval

Status 5: Pending Account Manager DOU Review

Status 6: Pending DPE Approval

Status 7: Approved

(The present invention can also be implemented with a different number and type of stages and Status.) The progression of status of each Service and the DOU encompassing the Service are described below. As people enter information into program 50 to define the Service and/or enter their approvals, program 50 automatically updates the status of the Service and DOU accordingly, and generates the DOU.

### Workflow for Defining a Service and Creating a DOU

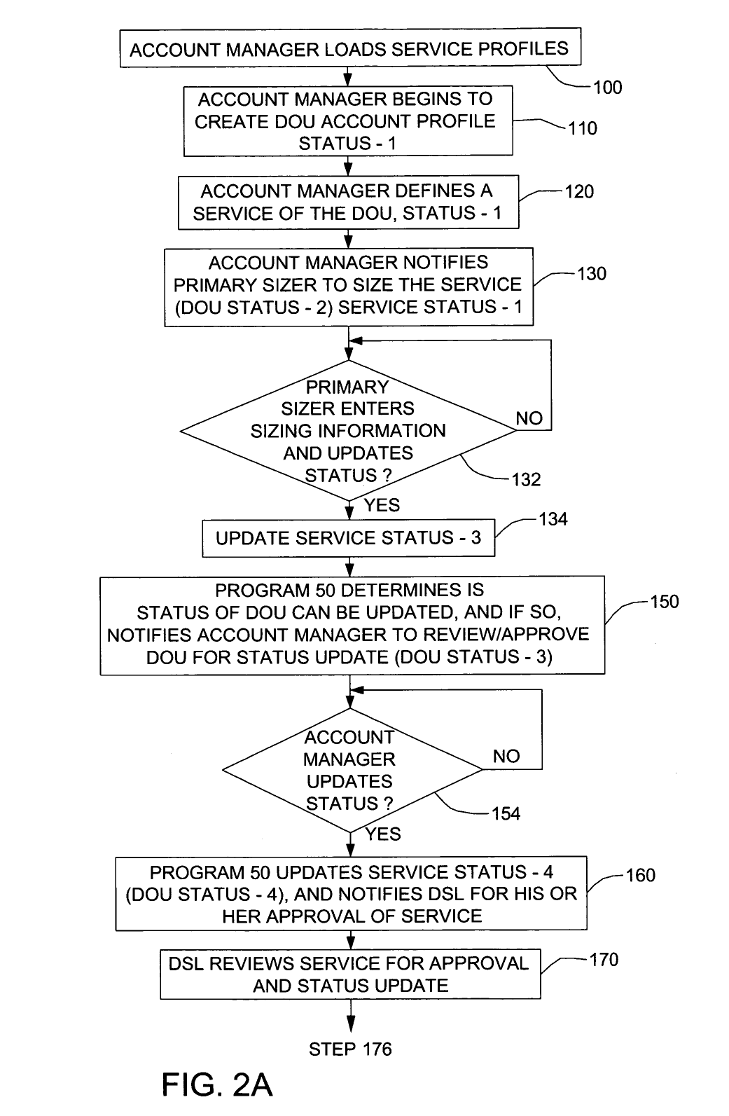

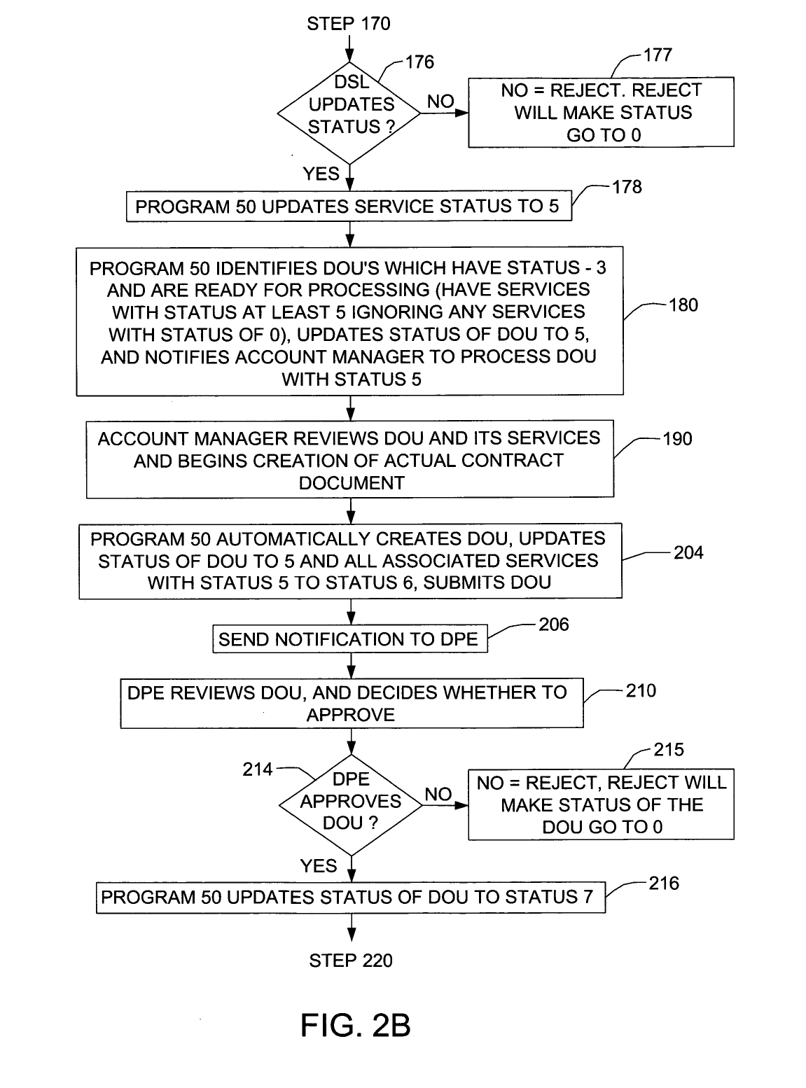

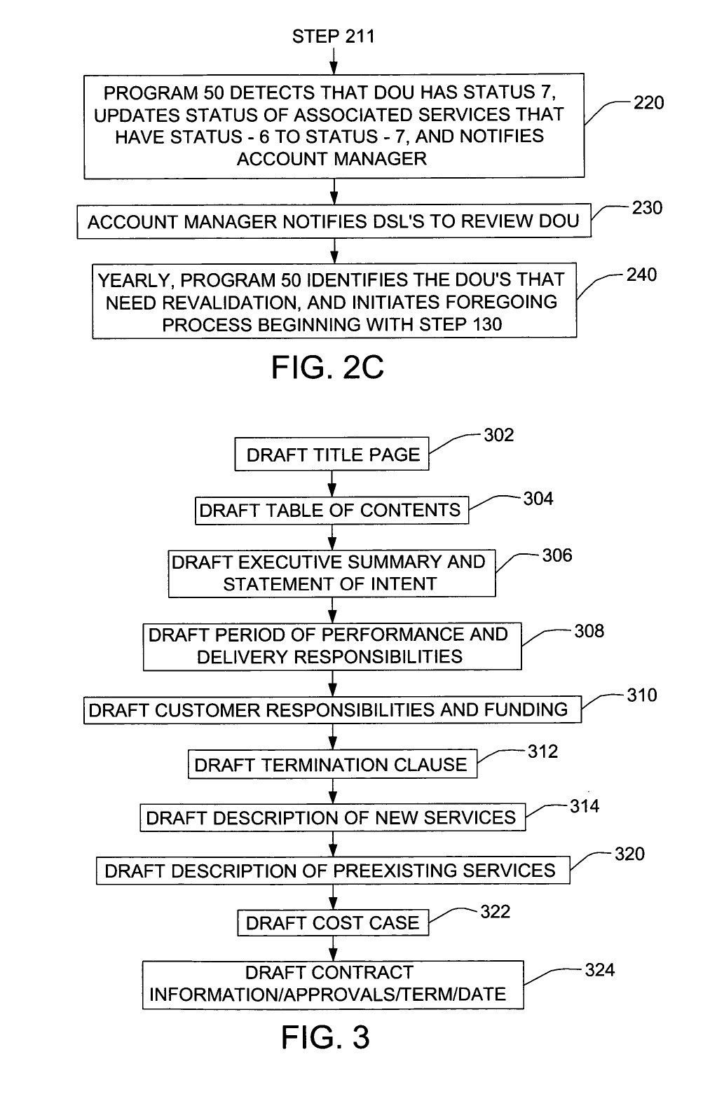

FIGS. 2(A-C) illustrates a workflow including program 45, according to the present invention to define and approve each Service of a DOU and automatically create the DOU for all the services. Program 45 includes a Process Manager program 50 including a status manager program function 67. During this workflow, program 50 updates the status of each Service and the status of the DOU accordingly.

In step 100, an Account Manager invokes a user interface screen from program 50 and requests that a Service Description Manager program module 51 load into working memory Service Profiles 53 for all Services that his or her organization supports. Each Service Profile has the following pre-defined/default information about its Service: Name of Service, Description of Service, Delivery Service Leader, Primary Technical Sizer, Secondary Technical Sizer and Service Worksheet template. The Service Profile serves as a template for defining the actual Services of the DOU.

In step 110 (DOU and Service Status 1), the Account Manager invokes a DOU creation program module 58 via the user interface screen to begins to create a DOU Account Profile 55. In the illustrated embodiment of the present invention, only an Account Manager can create a DOU Account Profile. DOU Status 1 allows the Account Manager to create a DOU without processing it. Each DOU has the following fields (entered by the Account manager): Customer Name, Project Name, Status, DPE's identification, Start Date, Completion Date, Contract Period, Line Of Business, Account Manager identification, Project Manager's identification, Type of DOU, ICA Number, and ICA Expiration Year. The Account Manager enters through the user interface.

In step 120 (DOU and Service Status 1), the Account Manager uses the user interface screen of program 50 to invoke the Service Description Manager Program 51 to define as a Service document 57 one of the Services of the DOU. In the illustrated embodiment of the present invention, only an Account Manager can define a Service. As noted above, there are typically two or more Services defined in each DOU Account Profile, and steps 120-240 are repeated for each Service. The Account Manger clicks a button on the screen called “Create Service” associated with the DOU to begin to define a Service. In response, program 51 displays a dialog box with a list of Service Profiles. The Account Manger then selects one of the Service Profiles to serve as a template to create one of the Services of the DOU. Each Service has a predefined/default Primary Sizer and Delivery Service Leader loaded from the Service Profile. The Account Manger can then edit and update the Service based on the current situation. The Service is defined by the following sections: Service Information, Service Request Information, Sizing Kickoff Information, Service Information Sizing Worksheet, and Costing Information (i.e. estimating the cost of the Service). As noted above, a Service Request can either be a preexisting template or be entered manually. Program 50 can import preexisting service requests from the Service Request Tool and New Business Database. The Account Manager enters the remainder of the fields manually.

(If the Account Manager wants to add a new Service to an existing DOU which has already been approved (and has Status 7), then program 50 adds the new Service as an addendum to the existing DOU, and changes the status of the DOU to Status 2—Pending Sizing (or Work in Progress). If an Account Manager selects a Service Profile for an existing Service then program 51 makes the new Service an addendum to the original Service. For example, if there is an existing service defined in the DOU as “Host Intrusion Detection” (HID) then every additional HID service in the DOU is considered an addendum to the first instance of the same service.

In step 130 (DOU and Service Status 1), the Account Manager clicks on a “Sizing Notification” button on the screen for the Service to start processing the DOU and Service. In response, program 50 sends a notification to the Primary Sizer instructing him or her to enter sizing and other information into the Service description. In response, program 50 updates the status of the Service and DOU to Status 2. In the illustrated embodiment of the present invention, to perform the Sizing, the Primary Sizer completes a predefined Sizing Worksheet/Table that is displayed on the user interface screen. By way of example, if the Service is to protect against malicious intrusions, the worksheet/table could be the following:

| | (Name of | (Name of |
|---|---|---|
| Responsibility/Task | Organization) | Organization) NA |
| Identify servers to be protected | P | |
| against malicious intrusion | | |
| Provide information about networks | | P |
| which access servers | | |
| Procure, initially build and | P | |
| initially configure intrusion | | |
| protection detection systems | | |
| Test intrusion protection system | A | P |
| Install, reconfigure and register | A | P |
| intrusion detection systems | | |
| Tune intrusion detection system | P | A |
| Steady state support of intrusion | | |
| detection system | | |
| Assess events detected by | P | |
| intrusion detection system | | |
| Report events monthly | P | |

Note:
“P” means to perform the task.
“A” means to assist in performance of the task.

The foregoing worksheet defining a specific type of Service and the tasks of the Service are just an example for purposes of illustration; the type of Service and its tasks will vary as needed.

In step 140 (DOU and Service Status 2), after the Primary Sizer has completed his or her Sizing entry, he or she clicks a “Complete Sizing” action button on the user interface screen (decision 132, yes branch). In response, program 50 closes the Service document and updates the status of the Service document to Status 3—Account Manager Costing (step 134).

In step 150 (DOU and Service Status 3), on a nightly or other periodic basis, the Account Manager Tool Agent 48 evaluates all DOUs stored by program 50 to determine it the Account Manager should process it. If the status of the DOU is Status 2 and all other Services within the DOU have Status 3 or higher (all Services that have Status 0 are ignored by program 50), then program 50 updates the status of the DOU to Status 3. Next, the Agent 48 sends a notification to the Account Manager stating that the DOU is ready for his or her action. If the status of any Service is below Status 3 and is not Status 0, then the Agent will not notify the Account Manager to update the status of the DOU. For example, if one Service has Status 1 or 2, the Account Manager Tool Agent will not update or notify the account manager.

In decision/step 154 (DOU and Service Status 3), the Account Manager reviews and/or updates the DOU Account Profile and Services document. For example, the Account Manager has the authority to change any section or field as he or she deems appropriate. Once the DOU is ready for DSL approval, the Account Manager clicks on a “DSL Approval Notification” action button on the user interface screen associated with the DOU Account Profile. In response, program 50 selects all the Services that have Status 3. Program 50 then updates the status of the DOU and selected Services to Status 4—Pending DSL Approval, and program 50 sends a notification to the selected DSLs for their review (step 160).

In step 170 (DOU and Service Status 4), after the DSL receives the notification to act on the Service, the DSL invokes a user interface screen which program 50 generated for display on workstation 14. The user interface screen can be an HTML accessed by the DSL's web browser. Then the DSL reviews the Service and decides whether to “Approve” or “Reject” it (decision 176). If not (decision 176, no branch), program 50 changes the Status of the Service to Status 0 (step 177). However, if the DSL decides to approve the Service (decision 176, yes branch), he or she clicks an “Approve” action button on the user interface screen generated by program 50. The approve action will capture the signature of the approver. The signature consists of the Date and Time of the approval and the Lotus Notes or other identification of the DSL used to access the user interface screen on workstation 14. Also, program 50 updates the status on the Service to Status 5—Pending Account Manager DOU Review (step 178).

In step 180 (DOU Status 5), on a nightly or other periodic basis, the Account Manager Tool Agent 48 evaluates all the DOUs generated by program 45 to determine whether the Account Manager should take action on a DOU for further processing. If a DOU has Status 4, i.e. “Pending DSL Approval” and the other Services associated with the DOU have Status 5 or higher status level, the Agent 48 updates the status of the DOU to Status 5, i.e. “Pending Account Manager DOU Review”. Next, the Agent 48 sends a notification to the Account Manager stating that the DOU is ready for his or her action. If any Services within the DOU has less than Status 5 and is not Status 0, then the Agent 48 does not notify the Account Manager or update the status. Also, if the DOU has Status 1 through 3 or Status 0, i.e. Rejected, On Hold or Canceled then the Agent 48 will not initiate processing of the DOU.

In step 190 (DOU Status 6), the Account Manager reviews and updates the DOU and its Services. Once the DOU is ready for Delivery Project Executive approval, the Account Manager: (a) clicks on a “Create DOU file” action button to begin creating the actual DOU document, (b) reviews and edits the template DOU Contract file that is displayed, (c) attaches the edited DOU document to the DOU Account Profile, and (d) clicks a “Submit to DPE for Approval” action button. In response, program 50 updates the status of the DOU to Status 6, i.e. “Pending DPE Approval”. Also, program 50 updates the status of all Services within the DOU that have Status 5—“Pending Account Manager DOU Review” to Status 6—“Pending DPE Approval”. Also, program 50 creates a preformatted notification for the Account Manager to send to the DPE.

Next (DOU Status 6), the Account Manger clicks a “Create DOU file” action button on the user interface associated with the DOU profile. In response, a DOU creation program module 58 within program 58 builds a DOU Contract File 63 to be the DOU (step 204).

Step 204 is further illustrated in FIG. 3. For the DOU/Contract File, program 58 builds a Title Page using a template and specific fields (for example, Customer Name, Project Name, Line of Business and Account Manager) found in the DOU Account Profile (step 302). Next, program 58 dynamically builds a Table of Contents page based on where each page section ends in the Word file (step 304). Next, program 58 fetches fields from the DOU Account profile for an “Executive Summary and Statement of Intent” section (step 306). Account Manager entered the contents of this field in step Customer Name (step 110). The “Executive Summary and Statement of Intent” is a high level summary of the Services to be provided by each organization represented by the DOU. Next, program 58 builds a “Period of Performance” section and a “Delivery Responsibilities” section using predefined/default text (step 308). The Delivery Responsibilities are the responsibilities of the service delivery organization under the DOU. Next, program 58 fetches fields (including the Customer Name fields) from the DOU Account Profile for the “Delivery Project Executive Responsibilities” and “Funding” sections (step 310). Next, program 58 builds a “Termination” section using predefined text (step 312). Next, program 58 dynamically builds an Appendix A—“Services Document” section based on all the Services that are not addenda (step 314). Each service in the Appendix A section has a Service Profile description which includes the Service “Sizing Worksheet/Table” table that the Account Manger previously defined in step 130. Next, program 58 builds an Appendix B—Service Addenda section like Appendix A except that Appendix B is based on the Services that are addenda (step 320). Next, program 58 builds an Appendix C—“Cost Case” section, but is empty until the Account Manager subsequently enters/updates it manually with the Costing information (step 322). Next, program 58 builds a “Contract Information/Approvals/Term/Date” section listing all the required DSL approvals for each Service listed for the DOU profile (step 324). Once the Account Manager updates and completes the DOU Contract File, the Account Manager attaches the file to the respective DOU profile. Then, program 58 notifies the DPE to take action on the DOU (step 326).

Referring again to FIGS. 2(A-C), in step 210 (DOU Status 6), after program 50 notifies the DPE to take action on the DOU, the DPE opens the DOU Account Profile using the DPE user interface screen. From the DOU Account Profile, the DPE opens the DOU Contract file. If the DPE agrees with the terms of the DOU Contract (decision 214, yes branch), the DPE clicks on an Approve action button associated with the DOU Account Profile. In response, program 50 updates the DOU Status to 7—“Approved” (step 216). If the DPE rejects the DOU, then program 50 changes the status to Status 0 (step 215).

In step 220 (DOU Status 7), on a nightly or other periodic basis, the DPE Approval Agent 56 evaluates all the DOUs in program 50 to determine when the Account Manager should take further action on a DOU. If the DOUs has Status 7—“Approved”, and the DOU has not been processed for completion then program 50 updates the status of all Service documents associated with the DOU that have Status 6, i.e. “Pending DPE Approval” to Status 7—“Approved”. Next, the Agent 56 sends a notification to the Account Manager stating that the DOU is ready for his or her action.

In step 230 (DOU and Service Status 7), after the DPE approves the DOU contract, the Account Manager notifies the DSL(s) about the approved DOU as follows. First, the Account Manager clicks a “DSL Notification/DPE Approval” action button for the approved DOU. In response, program 50 will display a list of approved Services. Next, the Account Manager can select one or more Services to confirm their approval, and if all the Services within a DOU have been approved, program 50 will notify the DSL(s) that the DOU has been approved. The notification has a link to the DOU account profile and all the Services.

In step 240 (DOU and Service Status 7), on a yearly or other infrequent period, the Revalidation Agent 56 evaluates all the DOU profiles generated by program 45 having Status 7—Approved, to determine whether they need to be revalidated. If a DOU has Status 7, the Agent 56 archives a copy of the DOU, DOU Contract file and Services in the Archive Data Base. Next, Agent 56 updates the status of the DOU profile and the Service(s) to Status 2, i.e. “Work In Progress”. Also, Agent 56 removes the DOU Contract file attachment from the DOU profile. Also, Agent 56 sends a notification to the Account Managers stating that the DOU is ready to be reprocessed for the current year. Agent 56 also updates all Services that were addenda in a previous year to reflect that they are not addenda for the New Year.

The following describes in more detail the algorithm/program steps within the status manager program 67 to determine the status of each Service and the status of the associated DOU. As indicated below, the status of the DOU is dependent in many cases on the status of the Services encompassed by the DOU.
If Account Manager clicks “Create, Account Profile” then DOU Status=1 (Draft).
If Account Manager clicks “Create Service” from DOU then Service Status=1 (Draft)
If Account Manager clicks “Sizing Notification” on Service then DOU Status=2 (Work in Progress) and Service Status=2 (Pending Sizing).
If Primary Sizer clicks “Complete Sizing” on Service then Service Status=3 (Account Manager Costing).
If Account Manager Agent evaluates DOU Status=2 and at least one Service Status=3 and all other Services Status=3 or greater (ignoring any Service Status=0) then DOU Status=3 (Account Manager Costing).
If Account manager clicks “DSL Approval Notification” on the DOU then DOU Status=4 (Pending DSL Approval) and all Services Statuses=3 are updated to Status 4 (Pending DSL Approval).
If Delivery Service Leader clicks “Approve” on the Service then Service Status=5 (Pending Account Manager SSA Review).
If Delivery Service Leader clicks “Reject” on the Service then Service Status=0 (Rejected and the program would remember the service's last good status of 4—Pending DSL Approval).
If Account Manager Agent evaluates DOU Status=4 and at least one Service Status=5 and all other Services Status=5 or greater (ignoring any Service Status=0) then DOU Status 5 (Pending Account Manager SSA Review).
If Account Manger clicks “Submit to DPE for Approval” then DOU Status=6 and all Services Statuses=5 is updated to Status 6 (Pending DPE Approval).
If Delivery Project Executive clicks “Approve” then DOU Status=7.
If Delivery Project Executive clicks “Reject” then DOU Status=0. (Rejected and the program would remember the service's last good status of 6—Pending DPE Approval).
If Delivery Project Executive Approval Agent evaluates DOU Status=7 and at least one Service Status=7 and all other Services Status=6 or greater (ignoring any Service Status=0) then Service Status=7 (Approved).
IF Account Manager clicks “On Hold” or “Canceled” on the DOU then the DOU Status=0 (On Hold or Canceled status is considered an exception. The Status manager remembers the last good status of each DOU.)
IF Account Manager clicks “On Hold” or “Canceled” on any Service then the Service Status=0 (On Hold or Canceled status is considered an exception. The Status manager remembers the last good status of each Service.)
If Revalidation Agent evaluates DOU for Year End=7 (Approved) then the DOU, DOU File and respective Services are Archived and all Services that have Status=0 (On Hold, Terminated, Rejected) are deleted.
   Program 45 can be loaded into server 30 from computer readable medium such as a magnetic disk or tape, CD ROM, DVD, etc. or downloaded from the Internet via the TCP/IP adapter card on server 30.

Based on the foregoing, a system, method and program product have been disclosed for defining and approving terms of a contract (formal or informal), and drafting the contract. However, numerous modifications and substitutions can be made without deviating from the scope of the present invention. Therefore, the present invention has been disclosed by way of illustration and not limitation, and reference should be made to the following claims to determine the scope of the present invention.

1. A computer program product for defining and approving first and second services of a contract, said program product comprising:
a computer readable medium;
first program instructions to solicit from at least one person first and second descriptions of said first and second services, respectfully;
second program instructions, responsive to receipt of said first and second descriptions, to notify at least one approver that said first and second services are ready for approval; and
third program instructions, responsive to receipt of said approval, to advance a status of said first and/or second services, respectively and determine a status of said contract, wherein said status of said contract is based on status of both said first and second services; and wherein
said first, second and third program instructions are stored on said medium.

2. A computer program product as set forth in claim 1 further comprising:
fourth program instructions to automatically enter some of said first and second descriptions into a document to form said contract; and wherein
said fourth program instructions are stored on said medium.

3. A computer program product as set forth in claim 2 wherein said fourth program instructions finalize said contract after said contract attains a predetermined status.

4. A computer program product as set forth in claim 1 wherein in response to receipt of said first and second descriptions, said third program instructions advance a status of both said first and second services.

5. A computer program product as set forth in claim 4 wherein in response to approval by said approver of said first and second services, said third program instructions advance a status of said contract.

6. A computer program product as set forth in claim 1 wherein said contract is a document of understanding for organizations within a same company.

7. A computer implemented method for defining and approving first and second services of a contract, said method comprising the steps of:
soliciting from at least one person first and second descriptions of said first and second services, respectfully;
responsive to receipt of said first and second descriptions, notifying at least one approver that said first and second services are ready for approval; and
responsive to receipt of said approval, advancing a status of said first and/or second services, respectively and determining a status of said contract, wherein said status of said contract is based on status of both said first and second services.

8. A method as set forth in claim 7 further comprising the computer implemented step of:
automatically entering some of said first and second descriptions into a document to form said contract.

9. A method as set forth in claim 7 further comprising the computer implemented step of finalizing said contract after said contract attains a predetermined status.

10. A method as set forth in claim 7 wherein in response to receipt of said first and second descriptions, further comprising the computer implemented step of advancing a status of both said first and second services.

11. A method as set forth in claim 10 wherein in response to approval by said approver of said first and second services, further comprising the computer implemented step of advancing a status of said contract.

12. A method as set forth in claim 7 wherein said contract is a document of understanding for organizations within a same company.

13. A computer system for defining and approving first and second services of a contract, said computer system comprising:
means for soliciting from at least one person first and second descriptions of said first and second services, respectfully;
means, responsive to receipt of said first and second descriptions, for notifying at least one approver that said first and second services are ready for approval; and
means, responsive to receipt of said approval, for advancing a status of said first and/or second services, respectively and determining a status of said contract, wherein said status of said contract is based on status of both said first and second services.

14. A computer system as set forth in claim 13 further comprising:
means for automatically entering some of said first and second descriptions into a document to form said contract.

15. A computer system as set forth in claim 14 further comprising means for finalizing said contract after said contract attains a predetermined status.

16. A computer system as set forth in claim 13 further comprising means, responsive to receipt of said first and second descriptions, for advancing a status of both said first and second services.

17. A computer system as set forth in claim 16 further comprising means, responsive to approval by said approver of said first and second services, for advancing a status of said contract.

18. A computer system as set forth in claim 13 wherein said contract is a document of understanding for organizations within a same company.
